(19) United States
(12) Patent Application Publication
(10) Pub. No.: US 2023/0385580 A1
(43) Pub. Date: Nov. 30, 2023

(54) METHOD OF UTILIZING A MATRIX BARCODE, AN APPARATUS AND A SYSTEM CONFIGURED TO PERFORM THE SAME

(71) Applicant: CAMI Technologies Inc, Lebanon, OH (US)

(72) Inventors: T Randall Lane, Lebanon, OH (US); Carissa Smith, Lebanon, OH (US)

(73) Assignee: CAMI Technologies Inc, Lebanon, OH (US)

(21) Appl. No.: 18/324,465

(22) Filed: May 26, 2023

Related U.S. Application Data
(60) Provisional application No. 63/347,176, filed on May 31, 2022.

(51) Int. Cl. G06K 7/14

(52) U.S. Cl. CPC G06K 7/1417; H04L 67/02

(57) ABSTRACT

A method of utilizing a matrix barcode includes scanning the matrix barcode, determining if the matrix barcode is mapped to a code, mapping the matrix barcode to recorded video, in response to determining that the matrix barcode is not mapped to the code, and retrieving a previously generated video based on the code, in response to determining that the matrix barcode is mapped to the code.

### CROSS-REFERENCE TO RELATED APPLICATION

This application claims priority under 35 U.S.C. § 119 to U.S. Provisional Application No. 63/347,176, filed on May 31, 2022, the entire contents of which are incorporated herein by reference.

### FIELD

This document relates to methods and systems for utilizing a matrix barcode.

### BACKGROUND

Emotion is lost within several industries due to the lack of face-to-face interaction. For example, handwritten cards or typed notes may be utilized to relay a customized message for gifting, corporate, medical, education and other industries. However, currently there is no quick and easy way to apply a personalized, face-to-face message, to enhance the experience between people. For example, while a video may be uploaded to an online video sharing platform, such as You Tube, and a uniform resource location (URL) to that video may be embedded into a traditional quick response (QR) code, creating such a QR code linking the online video is a cumbersome process and the linked video is static.

### SUMMARY

In one or more example embodiments, a method, apparatus and system for Creating a Meaningful Interaction (CAMI) is provided. Utilizing a matrix barcode, such as a customed quick response (QR) code, referred to as a “CAMIcode,” the CAMI platform enhances personal engagement.

Through the CAMI app or website, a video message can be created, reviewed, and approved—instantly connecting that message to the CAMIcode. On the receiving end of a CAMIcode, simply utilize a native camera to view your personalized message.

CAMI allows for a one-step way to take a video (live or recorded) and convert the video into a format that can be embedded into a CAMIcode.

CAMI platform includes at least three models, CAMItag, CAMIdot, and CAMIconnect:

CAMItag consist of pre-printed and “create it yourself” hang tags that can be attached to any gift. CAMItag allows a user to easily develop up a short (e.g., a 29 second) personalized message that is associated with a CAMIcode on the tag. Review and approve your video for instant connection to the CAMIcode.

Using our software, a user can free of any downloads, use native camera to record a video. Upon review and approval, it is instantly converted to a CAMIcode. This can happen on a handheld or computer. It can happen locally or via a connected website.

CAMItag technology can be integrated with a business system for easy distribution of personalized messages. This could include industries like floral, wedding registry, and boutique-like retail. This plug in is unique that it can be hosted locally, while using our technology remotely. This feature allows it to be extremely versatile.

CAMIdots are pre-printed labels to be sold in 1, 3, or 10 packs at retail. CAMIdots provide a simple way to create unique instructions for any application. CAMIdots allow a user to create a longer (e.g., up to a 3-minute) video and instantly connect that video with the CAMIcode printed on your CAMIdot.

These CAMIdots are long-lasting materials with repositionable adhesive. They can be applied nearly anywhere and can be read with any smart device with a native camera. They use the base CAMIcode technology. CAMIdots are ideal for vacation home rentals, work instructions for any business process, or for any unique instruction that needs to be relayed to an individual. (For example, how to work the thermostat, how to clean certain equipment, and closing instructions.)

CAMIconnect utilizes the same functionality as CAMItag and CAMIdot but provides the unique ability to replace the video connected to a specific CAMIcode. Simply develop your video message, then replace the video on-the-fly based on your needs and requirements through an admin portal.

Managed through our admin software, users can change the content of an existing code with the click of one button. This allows the user to supply relevant content in a timely manner without additional cost or reprinting. To our knowledge, this is currently not being done in any form. It also allows content prior or current to be stored by the admin. Batch your CAMIcodes and begin to understand the ROI of a specific campaign—how many people are scanning the code, how often, the ability to identify re-engagement opportunities, and more. The CAMIcodes can gather metrics on the performance of each communication. These metrics can be used to determine effectiveness of contacts, customer engagement, brand loyalty as well as many other topics.

CAMIconnect is the easiest method to drive face-to-face messaging from leadership to employees, update internal marketing messages within an organization, or share your latest software features throughout the year. CAMIconnect's ability to send mass or individual messaging is unique. It come from the ability to program the tags in a manner that has both group and individual settings.

### BRIEF DESCRIPTION OF THE DRAWINGS

FIG. 1 illustrates a functional workflow of a method of mapping a video to a CAMI code and opening the video mapped to the CAMI code.

FIG. 2 illustrates a functional workflow of a method of creating a CAMI tag linked to content and scanning a CAMI code to view the created content.

FIG. 3 illustrates a functional workflow of a user accessing the CAMI Admin portal and the Partner portal to manage various features of the CAMI system.

### DETAILED DESCRIPTION

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

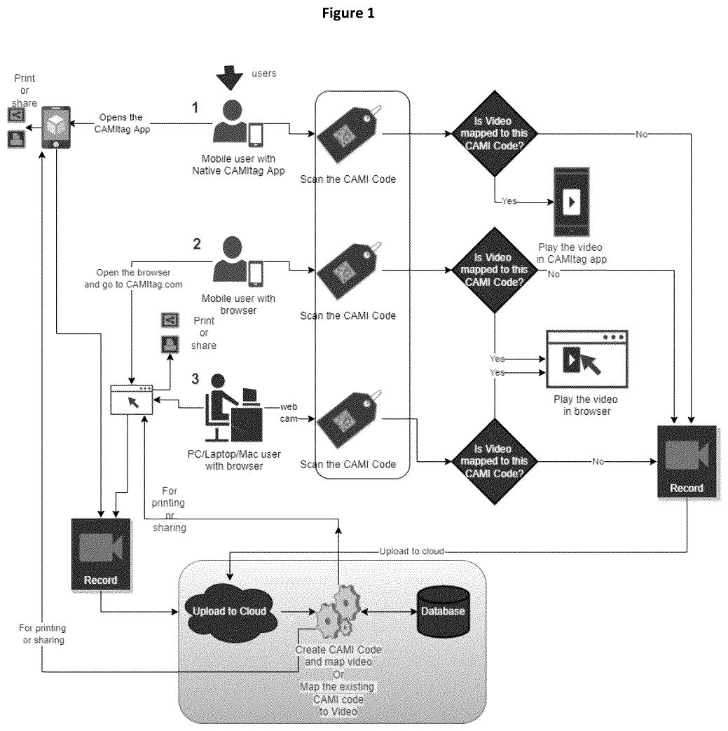

FIG. 1 illustrates a functional workflow of a method of mapping a video to a CAMI code and opening the video mapped to the CAMI code.

Referring to FIG. 1, a user access the CAMItag platform by, for example, opening a native CAMItag application their mobile device, via the CAMItag website on their mobile browser or via a browser on their personal computer.

As used herein, a mobile device may be any electronic device that is configured to communicate with an external communication network, such as the public or private communication networks described above. For example, a mobile terminal may a mobile phone, a smart phone, a tablet computer, a laptop, a digital camera, a media player, or any other such device that includes a digital camera or is capable of analyzing an image captured using a digital camera.

Via the CAMItag platform, the user may record their personalized message and upload the personalized message to CAMI's proprietary cloud storage. Alternatively, the user may first scan a pre-printed CAMI code, and the CAMItag platform may determine whether the scanned CAMI code is unassigned to a particular video. If the CAMI code is unassigned, the CAMItag platform may be instruct a user to create their personalized message and upload the personalized message to CAMI's proprietary cloud storage.

Thereafter, a user may scan the assigned CAMItag via for example, a user's camera on their mobile device controllable via the native CAMItag application or through control of the user's camera via the CAMItag website accessed via a mobile browser or a browser on a personal computer. The CAMItag platform may determine that the scanned CAMItag is assigned, and may automatically play the video in, for example, the native CAMItag application, via a mobile browser or via a browser on a personal computer.

In some example embodiments, the CAMItag may be secured such that the scanned tag is associated with additional information, such as a phone umber of the intended recipient, and the data associated with the CAMItag may not be accessible without the user entering additional information, such as their phone number. Alternatively, the user's phone number may be automatically determined when the CAMItag is accessed via the native application on their mobile device.

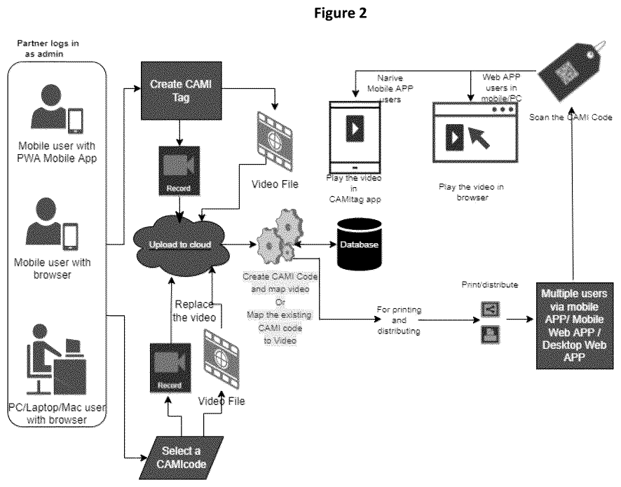

FIG. 2 illustrates a functional workflow of a method of creating a CAMI tag linked to content and scanning a CAMI code to view the created content.

Referring to FIG. 2, a user may access the CAMIdot platform by, for example, opening a native CAMItag application their mobile device, via the CAMItag website on their mobile browser or via a browser on their personal computer.

Via the CAMIdot platform, the user may either create a new CAMItag or replace the video associated with a previously created CAMItag. When the user creates a new CAMItag, the user may send the created CAMItag to print on a medium via the CAMIdot platform.

Thereafter, a user may scan the assigned CAMItag via for example, a user's camera on their mobile device controllable via the native CAMItag application or through control of the user's camera via the CAMItag website accessed via a mobile browser or a browser on a personal computer. The CAMItag platform may determine that the scanned CAMItag is assigned, and may automatically play the video in, for example, the native CAMItag application, via a mobile browser or via a browser on a personal computer.

In some example embodiments, data may be gathered from the CAMItag use and provided back to the creator of the CAMItag. Such data may include information, such as who, how many times, and when, the user read on the CAMItag.

Via the CAMIdot platform, a user may reformat an existing CAMItag to reassociate the CAMItag with new information, such as a different video clip. Such reformatting may allow, for example, a company to distribute a mousepad with a built in CAMItag and for management to provide monthly status updates to employees via the same CAMItag.

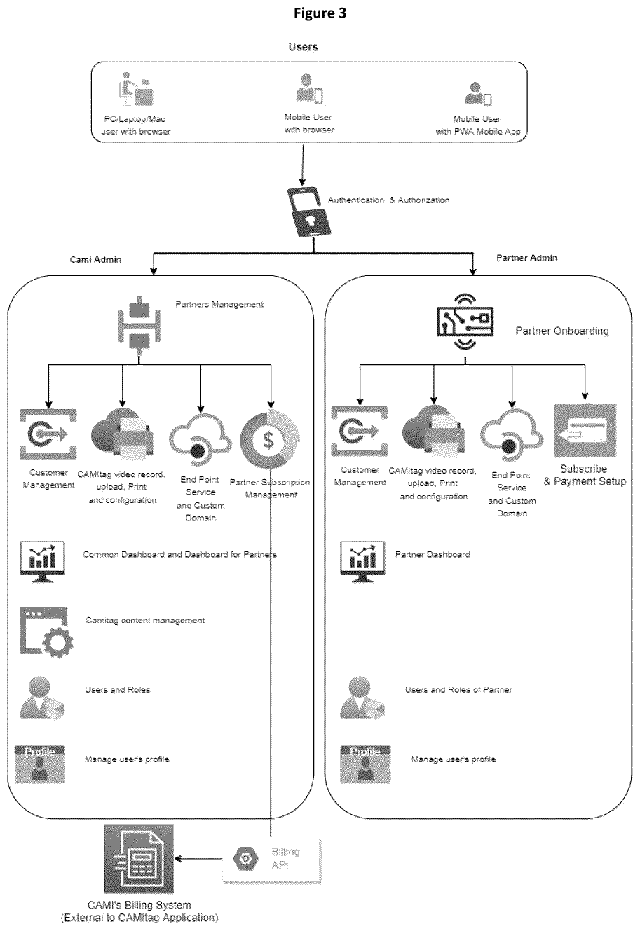

FIG. 3 illustrates a functional workflow of a user accessing the CAMI Admin portal and the Partner portal to manage various features of the CAMI system.

Referring to FIG. 3, a user may utilize the management platform by, for example, opening a native CAMItag application their mobile device, via the CAMItag website on their mobile browser or via a browser on their personal computer.

After authenticating as an administrator, the user my access the administrator dashboard to control, for example, customer management, CAMItag video record, upload, print and configuration, end point service and custom domains, and partner subscription management, in which the billing system for individual partners may be accessed and controller.

After authenticating as a partner, the user may access the partner dashboard to access the same information for their particular client account, and may also access the respective partners subscription and payment information.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Embodiments are described above with reference to block diagrams and/or operational illustrations of methods, systems. The operations/acts noted in the blocks may be skipped or occur out of the order as shown in any flow diagram. For example, two or more blocks shown in succession may be executed substantially concurrently or the blocks may sometimes be executed in the reverse order, depending upon the functionality/acts involved. While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments.

What is claimed is:

1. A method of utilizing a matrix barcode, the method comprising:
scanning the matrix barcode;
determining if the matrix barcode is mapped to a code;
mapping the matrix barcode to recorded video, in response to determining that the matrix barcode is not mapped to the code; and
retrieving a previously generated video based on the code, in response to determining that the matrix barcode is mapped to the code.

2. A method of managing a matrix barcode, the method comprising:
generating a graphical user interface (GUI) to allow an administrator to login to a portal;
remapping the matrix barcode from being associated with a first recorded video to being associated with a second recorded video, in response to the administrator instructing the matrix barcode to be remapped via the portal.

3. A method of controlling a dashboard for a matrix barcode, the method comprising:
accessing the dashboard to control one or more of customer management, video recording, uploading, printing and configuration, end point service and custom domains, and partner subscription management.
